(19) United States
(12) Patent Application Publication
(10) Pub. No.: US 2006/0247002 A1
(43) Pub. Date: Nov. 2, 2006

(54) Gaming machine with additionally visible symbols

(76) Inventors: Osamu Yoshimi, Botany (AU); Seiji Kato, Botany (AU)

Correspondence Address: KNOBBE MARTENS OLSON & BEAR LLP, 2040 MAIN STREET, FOURTEENTH FLOOR, IRVINE, CA, 92614, US

(21) Appl. No.: 11/299,099

(22) Filed: Dec. 9, 2005

(30) Foreign Application Priority Data
Feb. 14, 2005 (AU) AU2005900680

(51) Int. Cl. A63F 13/00

(52) U.S. Cl. 463/20

(57) ABSTRACT

A gaming machine for playing games of chance wherein a display of symbol containing elements determines a game outcome; said symbol containing elements comprising portions of simulated rotatable reels; said display comprising a matrix of said symbol containing elements as a first identifiable region and at least one adjoining additionally visible symbol containing element.

### RELATED APPLICATIONS

This application claims priority to Australian Provisional Patent Application No. 2005900680, filed Feb. 14, 2005, which is hereby incorporated in its entirety by reference herein.

### BACKGROUND

The present invention relates to gaming machines for the playing of games of chance and, more particularly, to special features of the display of game indicia on such machines.

Gaming, or poker machines, have become a major source of amusement and diversion in such places as clubs, hotels and casinos in many parts of the world.

Traditionally such machines were mechanical devices where a number of reels marked with a plurality of numbers or symbols could be made to spin randomly by the application of some mechanical input. If the subsequent patterns of numbers or symbols displayed on the reels, when these returned to a rest state, corresponded to predetermined patterns, the machine would provide a prize or payout. Generally such gaming machines have come to be regulated by government authorities as to their number and in the manner in which the machines must return a percentage of the monetary turnover to the players.

The introduction of electronics, computers and electronic graphical displays, has allowed a continual increase in the complexity and variations of gaming machines, games and displays while maintaining the basic concept of the traditional machine.

Machines and games that offer novel and stimulating variations on the basic game theme and environment are eagerly sought by the gaming industry and there is consequently intense competition between machine manufacturers to innovate.

Nevertheless the repetitive playing of even modern gaming machines can lead to boredom of the players with a consequent under-utilization of machines and increase in player dissatisfaction.

It is an object of the present invention to address or at least ameliorate some of the above disadvantages.

### BRIEF DESCRIPTION OF INVENTION

Accordingly, in a first broad form of the invention there is provided a gaming machine for playing games of chance wherein a display of symbol containing elements determines a game outcome; said symbol containing elements comprising portions of simulated rotatable reels; said display comprising a matrix of said symbol containing elements as a first identifiable region and at least one adjoining additionally visible symbol containing element.

Preferably, columns of said matrix comprise portions of said simulated rotatable reels; said reels segmented into a plurality of said symbol containing elements.

Preferably, said matrix comprises three rows and five columns of said symbol containing elements.

Preferably, said at least one adjoining additionally visible symbol containing element includes at least one said symbol containing element of at least one of said reels extending upwardly from said first identifiable region.

Preferably, said at least one adjoining additionally visible symbol containing element includes at least one said symbol containing element of at least one of said reels extending downwardly from said first identifiable region.

Preferably, said at least one adjoining additionally visible symbol containing element comprises two additional said symbol containing elements of at least one of said reels extending upwardly from said first identifiable region and two additional said symbol containing elements of at least one of said reels extending downwardly from said first identifiable region.

Preferably, any one of said symbol containing elements of said at least one adjoining additionally visible symbol containing element is displayed after an affine scale transformation whereby width of said element is maintained and height of said element is proportionally decreased.

Preferably, said affine scale transformation is applied to symbols contained in said symbol containing elements of said additionally visible symbol containing elements.

Preferably, symbols and elements of each succeeding additionally visible symbol containing element extending from said first identifiable region are subjected to a progressively increasing affine scale transformation such that said elements and symbols of each said succeeding additionally visible symbol containing element is of relatively reduced height.

Preferably, said elements are N-sided elements; where N is a variable and values of N include N=1.

Preferably, said values of N include 4, 5, 6, 7, 8, 9, 10, 11, 12, 13, 14, 15, 16, 17, 18, 19 and 20.

Preferably, said N-sided elements are regular hexagons.

In a further broad form of the invention there is provided a method of displaying additionally visible symbol containing elements of a game of chance played on a gaming machine; said method including the steps of:
1. displaying said symbol containing elements in a matrix forming a first identifiable region,
2. displaying at least one said additionally visible symbol containing element in an area adjoining said first identifiable region,

Preferably, said matrix and said at least one additionally visible symbol containing element comprise portions of adjoining simulated rotatable reels.

Preferably, a plurality of said at least one adjoining additionally visible symbol containing element comprises elements forming at least one additional row of said matrix of symbol containing elements.

Preferably, said method including the further step of:
3. applying an affine scale transformation to elements of said at least one additional row such that width of said elements is maintained and height of said elements is proportionally reduced.
4. applying said affine scale transformation to symbols of said symbol containing elements of said at least one additional row.

In yet a further broad form of the invention, there is provided a method of implementing a game of any one of claims 1 to 16 on a gaming machine; said gaming machine including an electronic display module and an input keyboard; said method including the steps of:
5. providing said gaming machine with a control module; said module including a microprocessor, a working memory and a data storage device,
6. writing program code to said data storage device,
7. connecting said data storage device to said control module.

In still a further broad form of the invention, there is provided media for storing enabling digital code for playing games according to any of claims 1 to 17; said media comprising solid state data retaining devices including, read only memory (ROM) and erasable programmable read only memory (EPROM), compact flash cards and PCMCIA cards; said media further including disc-based storage devices.

### BRIEF DESCRIPTION OF DRAWINGS

Embodiments of the present invention will now be described with reference to the accompanying drawings wherein:

FIG. 1 is a partial view of a gaming machine with a display panel showing a matrix of elements and symbols comprising portions of simulated rotatable reels,

FIG. 2 is a detailed front view of the display panel of FIG. 1 showing a first identifiable region and adjoining additionally visible symbol containing elements extending upwardly from the first identifiable region,

FIGS. 2A to 2E show a variety patterns of additional visible symbol containing elements extending from the first identifiable region.

FIG. 3A is a further detailed front view of the display of FIG. 2 showing two additional symbol containing elements for each of two reels extending upwardly from the first identifiable region,

FIG. 3B is a further detailed front view of the display of FIG. 2 showing two additional symbol containing elements for each of two reels extending downwardly from the first identifiable region,

FIG. 4 is a front view of the first identifiable region of FIGS. 2 and 3 with three additional rows of adjoining additionally visible symbol containing element wherein the elements of the additional rows have been subjected to an affine scale transformation.

FIG. 5 is a front view of the display of FIG. 2 showing additional rows in which both elements and symbols, have been subjected to an affine scale transformation.

FIG. 6 is a front view of the display of FIG. 2 wherein succeeding additional rows have been subjected to increasingly affine scale transformations.

FIGS. 7 and 8 are views of a display showing a first identifiable region in which the symbol containing elements are hexagons,

FIG. 9 is a schematic view of a display linked to a control module and keyboard,

FIG. 10 is a perspective view of a stand-alone, gaming machine arranged with a single display unit,

FIG. 11 is a front view of a stand-alone gaming machine with a main and a secondary display unit.

FIG. 12 is a perspective view of a number of the gaming machines of FIG. 10 or 11 when linked to a progressive jackpot system.

### DETAILED DESCRIPTION OF PREFERRED EMBODIMENTS

### First Preferred Embodiment

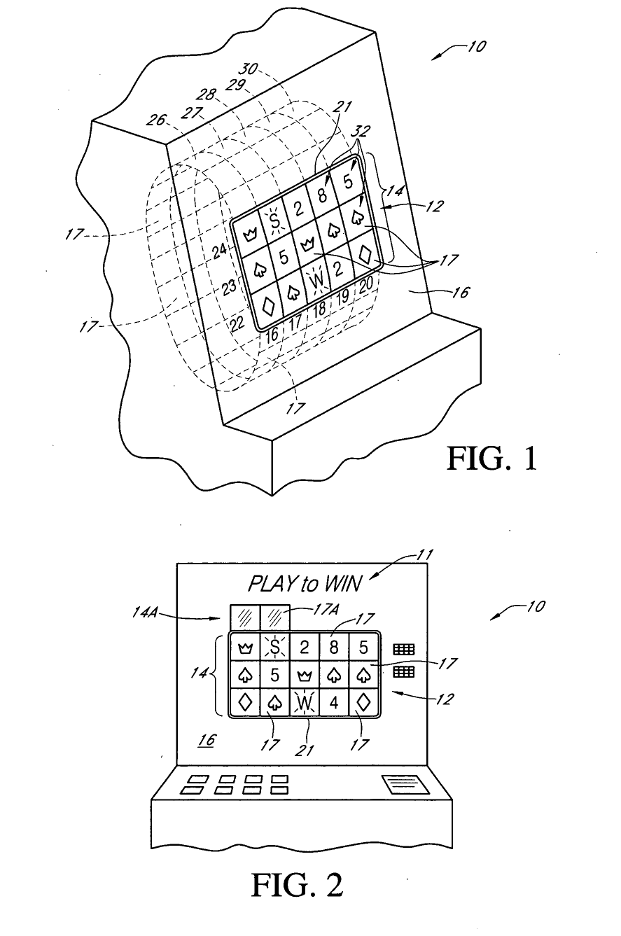

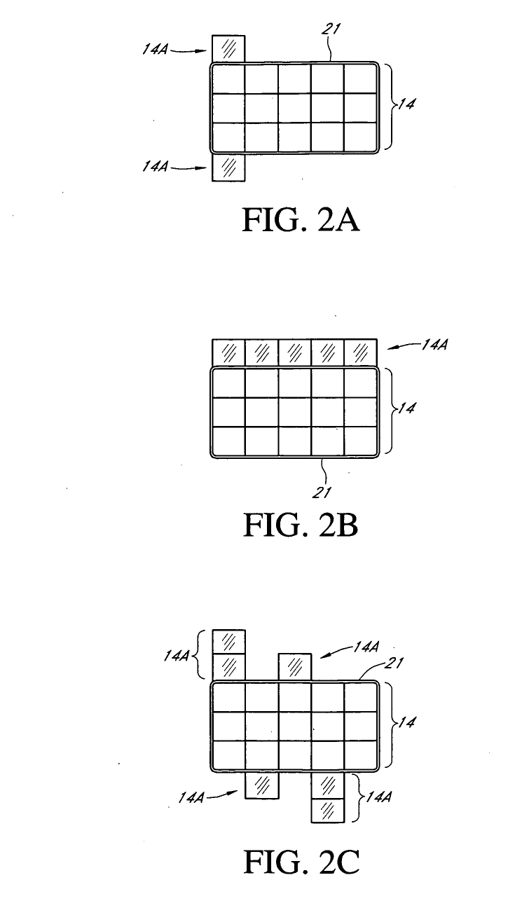

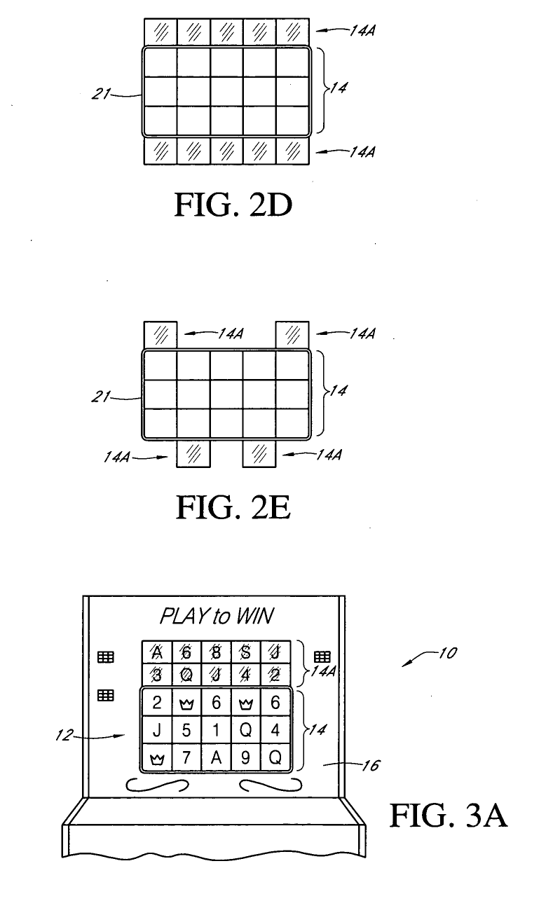

With reference to FIGS. 1 and 2, an electronic gaming machine 10 is arranged to project indicia 11 relating to games of chance playable on the machine 10 onto a display panel 16. Included in the projected display, is a first identifiable region 14 showing portions of a number of adjoining simulated rotatable reels 26 to 30. Each reel is divided into a given number of symbol containing elements 17, for example 256 elements. In this example the first identifiable region 14 is arranged to display five columns corresponding to each of the five reels 26 to 30 and three rows 22 to 24 as a matrix 12 of symbol containing elements when the reels are at rest.

Typically, the projected display surrounding the first identifiable region 14 is an opaque mask showing indicia relating to the playing of the game as well as decorative and promotional imagery 11. However, as shown in FIG. 2, in the present invention, the display is not limited to the five column and three row matrix of the first identifiable region 14 but may show one or more additional adjoining symbol containing elements 14A of one or more of the five reels.

Additional adjoining symbol containing elements may extend from either the upper or lower boundary of first identifiable region 14, or may extend from both, as for example in FIG. 2A.

In at least some forms of this preferred embodiment, one symbol containing element of each reel may be additionally visible to a player of the game, thus in effect, the matrix 18 then comprises four rows as shown in FIG. 2B. However, no restriction is envisaged on the number and disposition of additionally visible symbol containing elements. FIGS. 2c to 2E show examples of some of the possible configurations.

At all times during the playing of a game, the distinction between the first identifiable region 14, which may be regarded as the result matrix, and the additionally visible symbol containing elements, is maintained. This may be achieved in a number of ways. For example the result matrix may be displayed with a clearly defined border 21 such as shown in FIGS. 1 to 4. Alternatively, that portion of the display which, when the reels are at rest is defined as the result matrix, may be highlighted, for example by colour, while any additionally visible symbol containing elements are “greyed out”. In yet another form of this embodiment, the additionally visible symbol containing elements may appear as if seen through a translucent portion of the panel 16.

The adjoining additionally visible symbol containing elements 14A provide to the player an additional appreciation of the patterns of symbols on each of the simulated rotatable reels. Typically reels are simulated to rotate from the top to the bottom of the display area. When adjoining additionally visible symbol containing elements 14A when arranged as extending upwardly from the first identifiable region 14 as shown in FIG. 4, they provide a heightened sense of anticipation to a player who sees a larger number of the symbol containing elements approaching the rest position on a pay line as the reels slow to their rest position.

### Second Preferred Embodiment

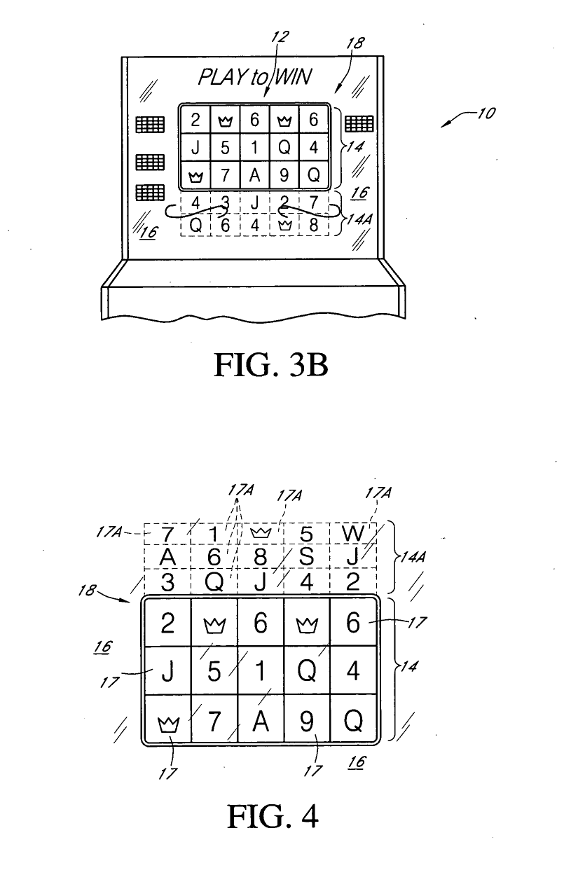

As shown in FIG. 3A, the displayed symbol containing elements of the five simulated rotatable reels 26 to 30 making up the columns of the matrix 18, is again comprised of a first identifiable region 14 and adjoining additionally visible symbol containing elements 14A. In this embodiment, adjoining additionally visible symbol containing elements 14A comprise two additional rows extending from the upper boundary of identifiable first region 14.

### Third Preferred Embodiment

As shown in FIG. 3B in a further particular preferred embodiment of the invention, the additionally visible symbol containing elements 14A comprise all the elements making up two additional rows extending downwardly from first identifiable region 14.

### Fourth Preferred Embodiment

With reference to FIG. 4, in this preferred embodiment also, the display of symbol containing elements 17 comprises a first identifiable region 14 and adjoining additionally visible symbol containing elements 14A, for example as visible through and below the indicia and imagery (not shown for clarity) projected onto the display panel 16.

The additionally visible symbol containing elements 14A include at least one additional symbol containing element 17A of at least one of the reels, but during the spinning of the simulated rotatable reels and when the reels are at rest, any additional elements 17A are subjected to an affine scale transformation. That is the width of the element or elements remains that of the width of the simulated rotatable reels and of the elements as displayed in the first identifiable region 14, but the height of each element 17A is reduced to a proportion of the height of the elements 17 as displayed in the first identifiable region 14. The example illustrated in FIG. 4 shows additionally visible symbol containing elements 17A making up three additional rows in which the elements have been subjected to an affine scale transformation.

### Fifth Preferred Embodiment

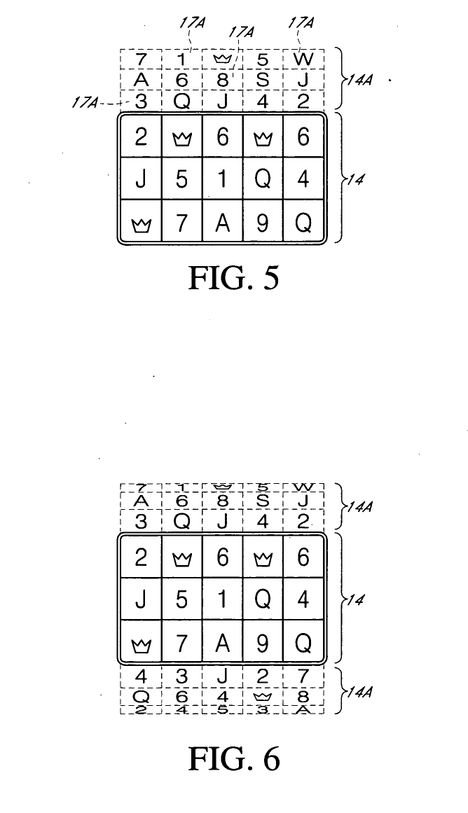

The reduction of the height of the additional elements 17A displayed as additionally visible symbol containing elements, may be limited to that height which allows the undistorted display of the symbol contained within that element, as shown in FIG. 4. However, in at least one preferred form of this embodiment as shown in FIG. 5, the symbols of elements 17A of adjoining additionally visible symbol containing elements 14A, may also be subjected to the same affine scale transformation, retaining their original width but being reduced in height.

The application of an affine scale transformation to the elements or to both the elements and the symbols contained therein, permits the display in the adjoining additionally visible symbol containing elements 14A of several additional rows, or portions of reels thus further adding to the interest of a player.

### Sixth Preferred Embodiment

It will be understood that the affine scale transformation applied to additionally visible elements 17A of each of a number of additional elements extending from first identifiable region 14, need not be the same affine scale transformation. Thus the proportional reduction of the height of each succeeding element of a reel and the symbol contained in that element extending away from the first identifiable region, may be subjected to increasing reductions. As shown in FIG. 6, this process will convey the impression to a player that he or she is viewing the actual upper and lower curved shoulders or limits of visibility of a reel.

### Seventh Preferred Embodiment

In this preferred embodiment of the invention, the matrix of symbol containing elements is only displayed as comprising a first identifiable region and adjoining additionally visible symbol containing elements when playing a feature game. The feature game or games may be awarded to a player of a primary game on the machine on the occurrence of some predefined triggering outcome or event of the main game.

Normally, during play of the main game, the display of symbol containing elements is limited to the first identifiable region, the remaining portions of the display panel showing only indicia and imagery associated with the playing of the main game, as well as any information on the potential of a player being awarded one or more feature games.

When a feature game is awarded, a portion of the display adjoining the first region becomes translucent, or adjoining additional symbol containing elements are rendered visible to the player in other ways.

### Eighth Preferred Embodiment

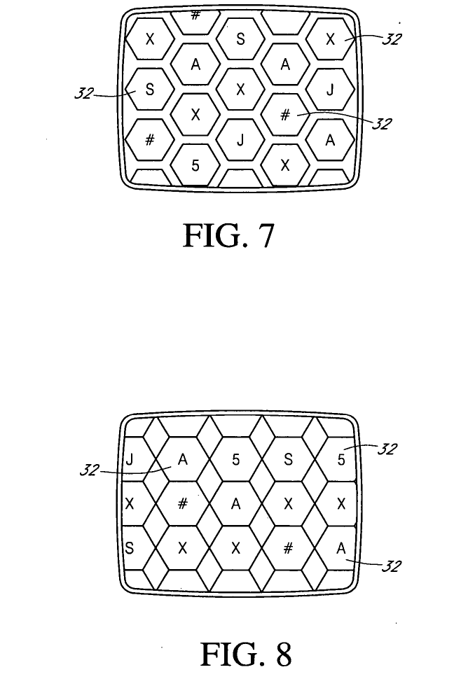

The elements comprising the matrix of elements of the above described embodiments may be of conventional rectangular configuration, but in at least one preferred embodiment the delineation of an element, that is, the boundary defining the field containing a symbol, may be any N-sided figure, where N may take the value 1 (thus a circular field) or any value from 3 to 20. In at least one preferred form of N-sided element, as shown in FIGS. 7 and 8, the elements 32 are hexagon shape for the value of N=6.

Game Implementation

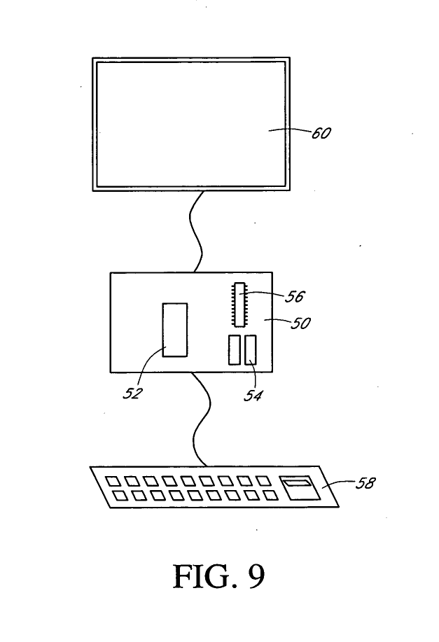

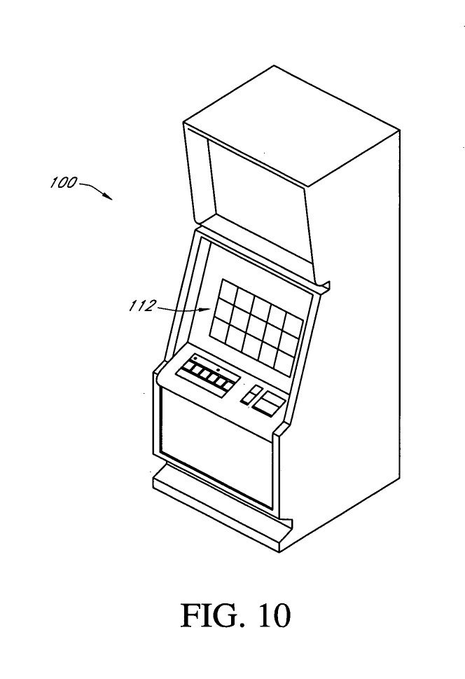

Any of the above described embodiments may be implemented on any gaming machine or group of gaming machine provided with a control module. As shown in FIG. 9, a control module 50 is provided with a microprocessor 52 and working random access memory (RAM) 54. The program code driving any of the described embodiments may be introduced into the control module 50 by connection of a data storage device 56. The device may take any of a number of forms, such as read only memory (ROM), erasable read only memory (EPROM), Compact Flash Card, PCMCIA card and the like. Alternatively, control module 50 may incorporate a hard disc drive to which the code may be written via a suitable input device.

Control module 50 acts to implement appropriate elements of the program code according to inputs from a user keyboard 58 and outputs video imagery to at least a main display module 60.

Examples of Gaming Machine Implementation

1. Stand-Alone Gaming Machines

As shown in FIG. 10, any of the above described embodiments for use on electronic display gaming machines may be incorporated into a stand-alone gaming machine 100 provided with a single display unit 112. In this implementation of games according to the invention, both main games and feature games (if offered) are displayed on the single display unit.

2. Stand-Alone Gaming Machines with Secondary Display Unit

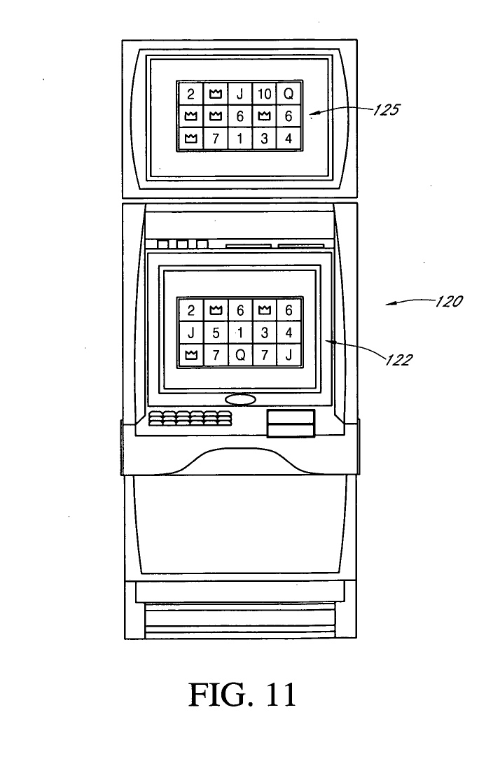

In a further preferred embodiment of the invention as shown in FIG. 11, a stand-alone gaming machine 120 is provided with a secondary display unit 125 as well as a main display unit 122. In this embodiment the main game played on the primary display unit may take the form of any of the first seven preferred embodiments described above.

Feature games are played, in this implementation on the secondary display unit. The feature game may, in one preferred form, be arranged in two phases; a first phase, where the matrix of symbol containing elements is restricted to the first identifiable region, and a second phase where the adjoining additionally visible symbol containing elements becomes visible. This second phase could occur for example after the simulated rotatable reels have come to rest. The player will then have some anticipation as to whether the initial pattern of symbols displayed in the first identifiable region may combine with some of those about to appear in the adjoining additionally visible symbol containing elements to constitute a winning combination.

3. Gaming Machines Linked to Progressive Jackpot System

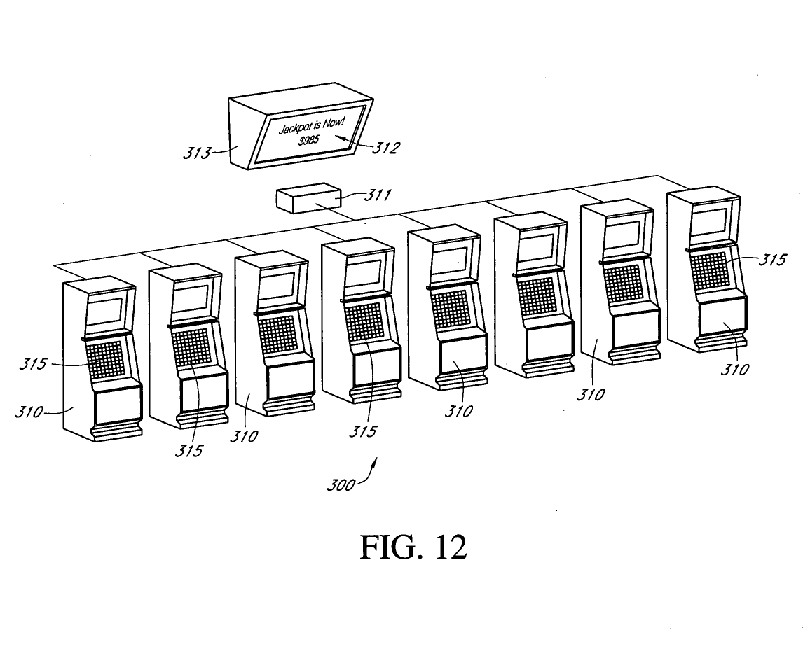

In yet a further preferred embodiment of the invention as shown in FIG. 12, a plurality of gaming machines 300 are arranged side by side in a line or arc so as to allow each of the players (not shown) of the machines to view a common jackpot prize display unit 313. Each individual machine 310 is provided with at least a main game display unit 315 for the playing of a main game according to any of the first seven above described embodiments

Each of machines 310 of the embodiment illustrated in FIG. 12 is electronically linked to a jackpot control module 311 which monitors the volume of play on each of the linked machines and displays an incrementing jackpot value 312 determined according to the combined volume of play on the linked machines.

A win of the jackpot prize may be triggered by specific outcomes of either a main game or of a feature game. If the jackpot trigger is dependent on an outcome of the feature game, players on adjoining machines may be made aware by means of the common display that a potential triggering of the jackpot is to commence on the machine offered the feature game, thus adding interest for all the players.

It will be appreciated that the linked machines may form part of Local Area Networks (LAN) or Wide Area Networks (WAN).

The above describes only some embodiments of the present invention and modifications, obvious to those skilled in the art, can be made thereto without departing from the scope and spirit of the present invention.

What is claimed is:

1. A gaming machine for playing games of chance wherein a display of symbol containing elements determines a game outcome; said symbol containing elements comprising portions of simulated rotatable reels; said display comprising a matrix of said symbol containing elements as a first identifiable region and at least one adjoining additionally visible symbol containing element.

2. The gaming machine of claim 1 wherein columns of said matrix comprise portions of said simulated rotatable reels; said reels segmented into a plurality of said symbol containing elements.

3. The gaming machine of claim 1 wherein said matrix comprises three rows and five columns of said symbol containing elements.

4. The gaming machine of claim 1 wherein said at least one adjoining additionally visible symbol containing element includes at least one said symbol containing element of at least one of said reels extending upwardly from said first identifiable region.

5. The gaming machine of claim 1 wherein said at least one adjoining additionally visible symbol containing element includes at least one said symbol containing element of at least one of said reels extending downwardly from said first identifiable region.

6. The gaming machine of claim 1 wherein said at least one adjoining additionally visible symbol containing element comprises two additional said symbol containing elements of at least one of said reels extending upwardly from said first identifiable region and two additional said symbol containing elements of at least one of said reels extending downwardly from said first identifiable region.

7. The gaming machine of claim 1 wherein any one of said symbol containing elements of said at least one adjoining additionally visible symbol containing element is displayed after an affine scale transformation whereby width of said element is maintained and height of said element is proportionally decreased.

8. The gaming machine of claim 1 wherein said affine scale transformation is applied to symbols contained in said symbol containing elements of said additionally visible symbol containing elements.

9. The gaming machine of claim 1 wherein symbols and elements of each succeeding additionally visible symbol containing element extending from said first identifiable region are subjected to a progressively increasing affine scale transformation such that said elements and symbols of each said succeeding additionally visible symbol containing element is of relatively reduced height.

10. The gaming machine of claim 1 wherein said elements are N-sided elements; where N is a variable and values of N include N=1.

11. The gaming machine of claim 9 wherein said values of N include 4, 5, 6, 7, 8, 9, 10, 11, 12, 13, 14, 15, 16, 17, 18, 19 and 20.

12. The gaming machine of claim 10 wherein said N-sided elements are regular hexagons.

13. A method of displaying additionally visible symbol containing elements of a game of chance played on a gaming machine; said method including the steps of:
displaying said symbol containing elements in a matrix forming a first identifiable region,
displaying at least one said additionally visible symbol containing element in an area adjoining said first identifiable region,

14. The method of claim 12 wherein said matrix and said at least one additionally visible symbol containing element comprise portions of adjoining simulated rotatable reels

15. The method of claim 13 wherein a plurality of said at least one adjoining additionally visible symbol containing element comprises elements forming at least one additional row of said matrix of symbol containing elements.

16. The method of claim 13 said method including the further step of:
applying an affine scale transformation to elements of said at least one additional row such that width of said elements is maintained and height of said elements is proportionally reduced.
applying said affine scale transformation to symbols of said symbol containing elements of said at least one additional row.
